(19) United States
(12) Patent Application Publication
(10) Pub. No.: US 2026/0228144 A1
(43) Pub. Date: Aug. 6, 2026

(54) SYSTEM-ON-A-CHIP (SOC) DEVICE WITH SECONDARY PROCESSOR FOR COLLECTION OF EXTERNAL DEVICE DATA

(71) Applicant: Microchip Touch Solutions Limited, Wokingham (GB)

(72) Inventor: Blake Hendry, Fareham (GB)

(73) Assignee: Microchip Touch Solutions Limited, Wokingham (GB)

(21) Appl. No.: 19/230,152

(22) Filed: Jun. 6, 2025

Related U.S. Application Data
(60) Provisional application No. 63/754,679, filed on Feb. 6, 2025.

(51) Int. Cl. G06F 13/28

(52) U.S. Cl. CPC G06F 13/28; G06F 2213/28

(57) ABSTRACT

A system-on-a-chip (SoC) device includes a primary processor, a primary memory accessible by the primary processor, a secondary processor, a secondary memory, and a communication interface. The secondary processor is configured to acquire external device data from an external device connected to the communication interface, store the acquired external device data in the secondary memory, and transmit the external device data from the secondary memory to the primary memory without interrupting the primary processor.

### RELATED APPLICATION

This application claims priority to commonly owned United States Provisional Patent Application No. 63/754,679 filed February 6, 2025, the entire contents of which are hereby incorporated by reference for all purposes.

### TECHNICAL FIELD

The present disclosure relates to a system-on-a-chip (SoC) device including a secondary processor for acquiring data from an external device, e.g., without interrupting the primary processor.

### BACKGROUND

In a typical microcontroller or other system-on-a-chip (SoC) device, when the CPU switches context, for example to run a different program, the state of the CPU must be saved (e.g., including storing current register values in memory) and the new state loaded in (e.g., new register values loaded in), which takes time. To read data from a sensor (for example a temperature sensor), the CPU must switch contexts for each sensor reading, for example by context switching to enter the relevant communication program (e.g., I²C program), send a request to the sensor, wait for a response, and then context switching back to the current task of the processer. Sensors that require frequent reads (e.g., at a 1 kHz frequency) may use a significant portion of time performing such context switching to collect sensor data, often leading to lags in the operation of a CPU tasks, which may be particularly problematic for time critical or real-time applications.

There is a need for an improved SoC device that reduces or eliminates CPU context switching for obtaining sensor data or other data from an external device.

### SUMMARY

Examples of the present disclosure provide an SoC device including (among other components) a primary processor (e.g., main CPU) and primary memory (e.g., RAM), and a secondary processor to control a communication interface (e.g., an I²C peripheral or other asynchronous communication peripheral) to acquire and store data from an external device (e.g., sensor data from an external sensor), wherein the secondary processor may subsequently transfer the acquired external device data to the primary memory (e.g., by Direct Memory Access (DMA) transfer) without requiring a CPU context switch or other interruption of the primary processor.

In some examples, the secondary processor may be a small, low power processor relative to the primary processor. For example, the secondary processor may comprise a finite state machine (FSM), a reduced instruction set computer (RISC) core, or other low power microprocessor or microcontroller. By adding such secondary processor, data may be collected from an external device and stored in a secondary memory and transferred asynchronously to the primary memory (e.g., RAM) of the main CPU (e.g., by DMA transfer) without CPU intervention. In some examples, the external device data may be pre-processed in the secondary memory, e.g., for batch processing and transfer to the primary memory.

The secondary processor may be configured to control or utilize the communication interface to communicate with one or more external device, e.g., one or more sensor, analog-to-digital converter (ADC), digital-to-analog converter (DAC), or other IC(s), to request and receive external device data (e.g., sensor data) from the external device(s), independent of the primary processor, i.e., without with requiring a CPU context switch or other interruption of the primary processor. This may be particularly advantageous when the primary processor (e.g., main CPU) is busy or in a deep sleep, as waking the CPU for context switching/sensor polling may consume significant power over time. In addition, this may be particularly advantageous for battery powered devices, as peripheral operation (e.g., reading data from sensors) can continue with a low powered secondary processor, while the main processor sleeps.

The secondary processor may store the received external device data in the secondary memory, e.g., in data packets, and subsequently transfer the external device data to the primary memory, e.g., by DMA transfer. In some examples, the secondary processor may transfer external device data to the primary memory in batches (e.g., each batch including multiple sensor data samples), for example to reduce the number and frequency of data transfers.

One aspect provides an SoC device, including a primary processor, a primary memory accessible by the primary processor, a secondary processor, a communication interface, the secondary processor configured to acquire external device data from an external device connected to the communication interface, a secondary memory to store external device data acquired from the external device, and the secondary processor configured to transmit the external device data from the secondary memory to the primary memory without interrupting the primary processor.

In some examples, the secondary processor comprises a finite state machine (FSM) or a reduced instruction set computer (RISC) core.

In some examples, the secondary processor operates at a lower frequency than the primary processor.

In some examples, the secondary processor is configured to control a direct memory access (DMA) controller to transmit the external device data from the secondary memory to the primary memory using a DMA transfer.

In some examples, the external device comprises a sensor, the external device data comprises sensor data samples, the secondary processor is configured to acquire a series of sensor data samples from the external device via the communication interface over time, the secondary memory is configured to store sensor data samples acquired from the external device, and the secondary processor configured to transmit the sensor data samples from the secondary memory to the primary memory without interrupting the primary processor.

In some examples, the SoC device comprises a microcontroller.

In some examples, the secondary processor is configured to perform pre-processing of the external device data acquired from the external device, wherein the pre-processing includes at least one of data filtering, averaging, unit conversion, or error detection, and transmit the pre-processed external device data from the secondary memory to the primary memory.

In some examples, the secondary processor is configured to acquire a series of external device data samples from the external device via the communication interface over time, store the series of external device data samples in the secondary memory, and transmit the external device data samples from the secondary memory to the primary memory in respective batches including multiple external device data samples.

In some examples, the secondary processor is configured to acquire the external device data from the external device, and store the external device data acquired in the secondary memory during a sleep state of the primary processor.

Another aspect provides a method, including storing instructions in a primary memory of a SoC device; accessing and executing the instructions, by a primary processor of the SoC device; controlling a communication interface of the SoC device, by a secondary processor of the SoC device, to acquire external device data from an external device connected to the communication interface; storing external device data acquired from the external device in a secondary memory of the SoC device; and transmitting, by the secondary processor, the external device data from the secondary memory to the primary memory without interrupting the primary processor.

In some examples, the secondary processor comprises an FSM or a RISC core.

In some examples, the secondary processor operates at a lower frequency than the primary processor.

In some examples, the method includes controlling a DMA controller, by the secondary processor, to transmit the external device data from the secondary memory to the primary memory using a DMA transfer.

In some examples, the external device comprises a sensor, the external device data comprises sensor data samples, and the method includes controlling the communication interface, by the secondary processor, to acquire a series of sensor data samples from the external device via the communication interface over time, storing sensor data samples acquired from the external device in the secondary memory, and transmitting, by the secondary processor, the sensor data samples from the secondary memory to the primary memory without interrupting the primary processor.

In some examples, the method includes pre-processing, by the secondary processor, the external device data acquired from the external device, wherein the pre-processing includes at least one of data filtering, averaging, unit conversion, or error detection, and transmitting, by the secondary processor, the pre-processed external device data from the secondary memory to the primary memory.

In some examples, the method includes controlling the communication interface, by the secondary processor, to acquire a series of external device data samples from the external device via the communication interface over time, storing the series of external device data samples in the secondary memory, and transmitting, by the secondary processor, the external device data samples from the secondary memory to the primary memory in respective batches including multiple external device data samples.

In some examples, the method includes entering the primary processor in a sleep state, and acquiring the external device data from the external device and storing the external device data acquired in the secondary memory, by the secondary processor, while the primary processor remains in the sleep state.

Another aspect provides a SoC device, including (a) a primary processor configured to operate in an active state and a sleep state, and (b) a secondary processor configured to, during a sleep state operation of the primary processor, acquire external device data from an external device connected to the SoC device and store the acquired external device data in memory.

In some examples, the secondary processor is configured to store the acquired external device data in a secondary memory, and transmit the external device data from the secondary memory to a primary memory accessible by the primary processor without interrupting the primary processor.

### BRIEF DESCRIPTION OF THE DRAWINGS

Example aspects of the present disclosure are described below in conjunction with the figures, in which:

FIG. 1 shows an example system including an example SoC device to acquire and store external device data from an external device (e.g., sensor) without interrupting a primary processor (e.g., main CPU) of the SoC device;

FIG. 2 shows an another example system similar to the system including an example SoC device to acquire and store external device data from an external device; and

FIG. 3 is a flowchart showing an example method for an SoC device to acquire and store external device data from an external device without interrupting a primary processor (e.g., main CPU) of the SoC device.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

The present disclosure provides a system-on-a-chip (SoC) device including (among other components) a primary processor (e.g., main CPU) and primary memory (e.g., RAM), and a secondary processor to control a communication interface (e.g., an I²C peripheral) to acquire data from an external device (e.g., sensor data from an external sensor), which data may be stored in a secondary memory and subsequently transferred to the primary memory (e.g., by Direct Memory Access (DMA) transfer) without requiring a CPU context switch or other interruption of the primary processor.

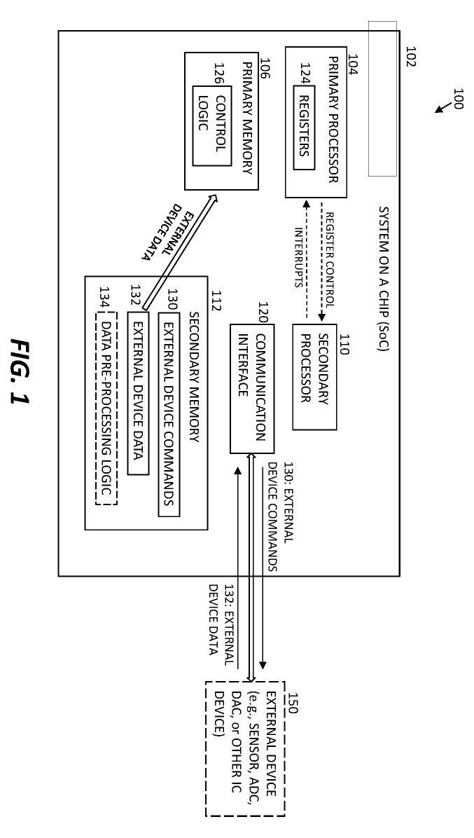

FIG. 1 shows an example system 100 including an example SoC device 102 and an external device 150. The example SoC device 102 includes a primary processor 104, a primary memory 106, a secondary processor 110, a secondary memory 112, and a communication interface 120. The primary processor 104 may comprise, for example, a CPU including CPU registers 124. In some examples, the example SoC device 102 may comprise a microcontroller.

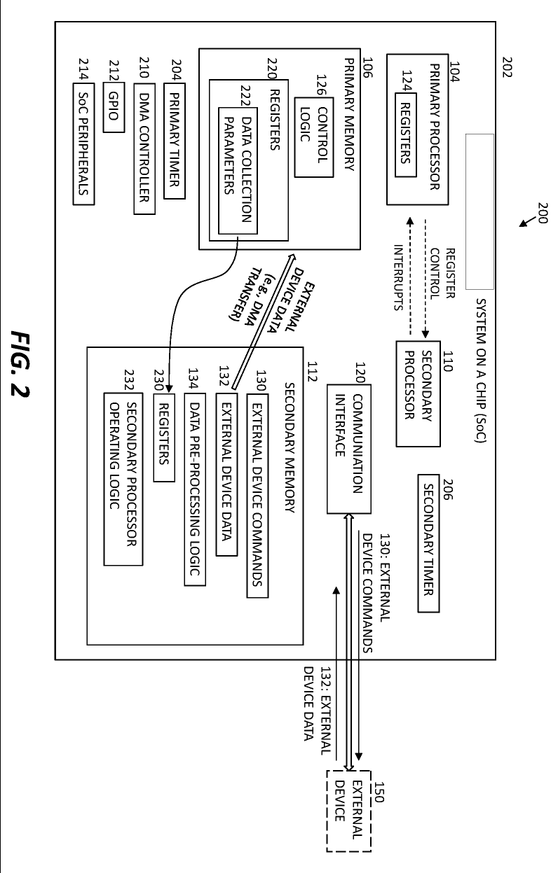

The primary memory 106 may include one or more memory devices (for example, one or more Random Access Memory (RAM), Read Only Memory (ROM), Flash memory, registers, and/or other memory devices) accessible to the primary processor 104. As shown, the primary memory 106 may store (among other information) control logic 126, e.g., embodied in software and/or firmware and executable by the primary processor 104 to perform various functions of the SoC. For example, control logic 126 may include (a) logic for controlling registers accessible by the secondary processor (e.g., registers 2xx discussed below with respect to FIG. 2) for example to control the timing and/or other parameters of data collection from the external device 150, and/or (b) logic defining which interrupts are enabled for the secondary processor 110.

The secondary processor 110 may comprise, for example, a finite state machine (FSM), a reduced instruction set computer (RISC) core, or other low power microprocessor or microcontroller. In some examples, the secondary processor 110 operates at a lower frequency (e.g., 8 MHz) than the primary processor 104 (e.g., 64 MHz) to conserve power, as speed may be less critical for secondary processor 110 functions (e.g., collecting and/or pre-processing data from the external device 150). Some examples may provide on-the-fly secondary processor clock division for power saving, while using different peripheral speeds (for example, 100kHz I²C only needs ~1MHz secondary processor clock speed, compared to 1MHz I²C needing 8-16MHz secondary processor clock speed).

The communication interface 120 (e.g., an asynchronous communication peripheral) may provide a communication link between the SoC 102 and the external device 150, for example to send external device commands 130 (e.g., requests for data) to the external device 150 to obtain external device data 132 (e.g., sensor data) from the external device 150. In some examples, the communication interface 120 may comprise an I²C, TWI (Two Wire Interface), SPI (Serial Peripheral Interface), UART (Universal Asynchronous Receiver/Transmitter), or SMBus (System Management Bus) controller.

The secondary memory 112 may include one or more memory devices (for example, one or more RAM, ROM, Flash memory, registers, and/or other type(s) of memory devices) accessible to the secondary processor 110. As shown, the secondary processor 110 may store external device commands 130 for transmission to the external device 150, external device data 132 obtained from the external device 150, and optionally data pre-processing logic 134 for pre-processing external device data 132 before transmission to the primary memory 106.

In operation, the secondary processor 110 may execute respective control logic to acquire external device data 132 from the external device 150, for example by sending external device commands 130 to the external device 150 via the communication interface 120, and in response, receiving requested external device data 132 via the communication interface 120. The secondary processor 110 may store the acquired external device data 132 in the secondary memory 112, and subsequently transmit the stored external device data 132 from the secondary memory 112 to the primary memory 106, without interrupting the operation of the primary processor 104. For example, the secondary processor 110 may transmit stored external device data 132 from the secondary memory 112 to the primary memory 106 without requiring a CPU context switch or other interruption of the primary processor 104. In some examples or instances, the secondary processor 110 may transmit stored external device data 132 from the secondary memory 112 to the primary memory 106 during a sleep state of the primary processor 104, without needing to wake the primary processor 104.

The ability to collect and store external device data 132 in secondary memory 112, and subsequently transfer the collected external device data 132 from the secondary memory 112 to the primary memory 106 may be particularly advantageous when the primary processor 104 (e.g., main CPU) is busy or in a deep sleep, as waking the CPU for context switching/sensor polling may consume significant power over time. In addition, this capability may be particularly advantageous for battery powered devices, as peripheral operation (e.g., reading data from sensors) can continue with a low powered secondary processor 110, while the main processor 104 sleeps.

In some examples, the secondary processor 110 may store acquired external device data 132 in the secondary memory 112 in data packets. In some examples, a user may define a packet design for data packets stored in the secondary memory 112, for example the following packet protocol for external device data 132 comprising temperature, humidity, and pressure sensor measurements: [PACKET NUMBER, DATA SIZE, data[TEMPERATURE, HUMIDITY, PRESSURE], CHECKSUM].

In some examples, the secondary processor 110 may control a DMA controller to transmit external device data 132 from the secondary memory 112 to the primary memory 106 using a DMA transfer.

In some examples, the secondary processor 110 may acquire external device data 132 from the external device 150 in the form of a series of external device data samples collected over time. The secondary processor 110 may store the series of external device data samples (i.e., external device data 132) in the secondary memory 112, optionally pre-process the data samples as discussed below, and subsequently transmit the data samples from the secondary memory 112 to the primary memory 106 in batches, with each respective batch including multiple data samples.

In some examples, the secondary processor 110 may execute data pre-processing logic 134 to pre-process external device data 132 (obtained from the external device 150) before transmitting the data 132 from the secondary memory 112 to the primary memory 106. Such pre-processing may include, for example, at least one of data filtering (e.g., to filter outlier data), averaging, unit conversion, or error detection, or data packet structuring.

After such pre-processing, the secondary processor 110 may transmit the pre-processed external device data 132 from the secondary memory 112 to the primary memory 106 (e.g., as individual pre-processed data samples, or in batches of pre-processed data samples), for example by DMA transfer.

FIG. 2 shows an example system 200 including an example SoC device 202 and an external device 150. The example SoC device 202 may correspond with the example SoC device 102 discussed above, wherein like numbers refer to like components, and showing additional components in the SoC device 202. Thus, SoC device 202 includes the primary processor 104 (including registers 124), primary memory 106 (storing control logic 126), secondary processor 110, secondary memory 112 (storing external device commands 130, external device data 132 obtained from external device 150, and optionally data pre-processing logic 134), and communication interface 120. In some examples, the example SoC device 202 may comprise a microcontroller.

In addition to the above, the example SoC device 202 may include a primary timer 204 associated with the primary processor 104, a secondary timer 206 associated with the secondary processor 110, a DMA controller 210, general-purpose input/output (GPIO) interfaces 212, and various SoC peripherals 214. In addition, the primary memory 106 may include first registers 220 storing data collection parameters 222, and the secondary memory 112 may include second registers 230 and secondary processor operating logic 232 executable by the secondary processor 110 for performing the various functions of the secondary processor 110.

The primary timer 204 may comprise a hardware counter used by the primary processor 104 to schedule tasks, keep track of time, and manage system resources. The primary timer 204 may interrupt counting (i.e., sleep) when the primary processor 104 enters a sleep or low-power mode.

The secondary timer 206 associated with the secondary processor 110 may comprise a hardware counter or a software- or firmware-implemented counter. The secondary processor 110 may use the secondary timer 206 for scheduling various functions, including scheduling data reads from the external device 150. In some examples, the secondary timer 206 may continue to operate (count) when the primary processor 104 enters a sleep or low-power mode, to thereby allow the secondary timer 206 to continue operation (e.g., performing data reads from the external device 150) while the primary processor 104 operates in a sleep or low-power mode.

The DMA controller 210 may be used by the secondary processor 110 for performing DMA transfers of external device data 132 (obtained from the external device 150) from the secondary memory 112 to the primary memory 106.

As noted above, the primary memory 106 may include first registers 220 storing data collection parameters 222. Data collection parameters 222 may define various details or aspects for collecting external device data 132 from the external device 150, for example, specifying (a) client address(es) for the external data device 150 (and/or other external data device(s)), (b) memory block pointers for requested external device data 130, (c) a frequency or timing of data collection (e.g., using respective external device commands 130), (d) a number of samples or otherwise defining an amount of external device data 132 in each data request, (e) a format of the external device data 132, and/or (e) any other parameters regarding the collection of external device data 132.

The primary processor 104 may be configured to transmit (e.g., copy) the data collection parameters 222 from the first registers 220 to second registers 230, such that the secondary processor 110 may access the data collection parameters 222 without interrupting the primary processor 104. In this manner, one or more data collection parameters 222 may be dynamically updated over time (e.g., based on user input) and transferred to second registers 230 for use by the secondary processor 110.

In another implementation, data collection parameters used by the secondary processor 110 for collecting external device data 132 from the external device 150 may be hard programmed (e.g., in firmware or software) in secondary memory 112, e.g., during an initial programming of the primary processor 104.

In addition, in some examples, the primary processor 104 may execute control logic 126 defining which interrupts are enabled for the secondary processor 110.

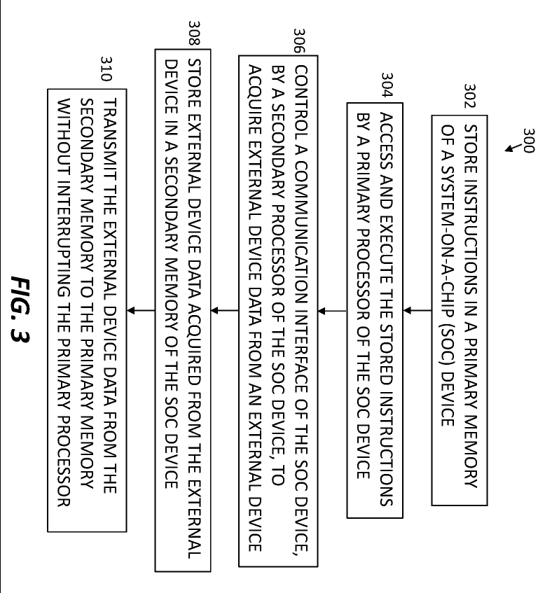

FIG. 3 is a flowchart showing an example method 300 for an SoC device (e.g., microcontroller) to acquire and store external device data from an external device without interrupting a primary processor (e.g., main CPU) of the SoC device. In some examples, the example method 300 may be performed by the example SoC device 102 shown in FIG. 1 or the example SoC device 202 shown in FIG. 2.

At 302, instructions are stored in a primary memory (e.g., RAM) of a SoC device. At 304, a primary processor (e.g., main CPU) of the SoC device accesses and executes respective stored instructions to perform various functions of the SoC device.

At 306, a secondary processor of the SoC device (e.g., a FSM or RISC core) may control a communication interface of the SoC device (e.g., an asynchronous communication peripheral ) to acquire (e.g., request and receive) external device data from an external device (e.g., a second) connected to the communication interface.

At 308, the secondary processor may store external device data acquired from the external device in a secondary memory of the SoC device. At some subsequent time, at 310 the secondary processor may transmit the external device data from the secondary memory to the primary memory (e.g., via a DMA transfer) without interrupting the primary processor. For example, the primary memory may remain in a sleep or low-power mode during the acquisition, storage, and/or transfer of the external device data by the secondary processor.

Although example embodiments have been described above, other variations and embodiments may be made from this disclosure without departing from the spirit and scope of these embodiments.

1. A system-on-a-chip (SoC) device, comprising:
a primary processor;
a primary memory accessible by the primary processor;
a secondary processor;
a communication interface;
the secondary processor configured to acquire external device data from an external device connected to the communication interface;
a secondary memory to store external device data acquired from the external device; and
the secondary processor configured to transmit the external device data from the secondary memory to the primary memory without interrupting the primary processor.

2. The SoC device of claim 1, wherein the secondary processor comprises a finite state machine (FSM) or a reduced instruction set computer (RISC) core.

3. The SoC device of claim 1, wherein the secondary processor operates at a lower frequency than the primary processor.

4. The SoC device of claim 1, wherein the secondary processor is configured to control a direct memory access (DMA) controller to transmit the external device data from the secondary memory to the primary memory using a DMA transfer.

5. The SoC device of claim 1, wherein:
the external device comprises a sensor;
the external device data comprises sensor data samples;
the secondary processor is configured to acquire a series of sensor data samples from the external device via the communication interface over time;
the secondary memory is configured to store sensor data samples acquired from the external device; and
the secondary processor configured to transmit the sensor data samples from the secondary memory to the primary memory without interrupting the primary processor.

6. The SoC device of claim 1, wherein the SoC device comprises a microcontroller.

7. The SoC device of claim 1, wherein the secondary processor is configured to:
pre-processing the external device data acquired from the external device to provide pre-processed external device data, wherein the pre-processing includes at least one of data filtering, averaging, unit conversion, or error detection; and
transmit the pre-processed external device data from the secondary memory to the primary memory.

8. The SoC device of claim 1, wherein the secondary processor is configured to:
acquire a series of external device data samples from the external device via the communication interface over time;
store the series of external device data samples in the secondary memory; and
transmit the external device data samples from the secondary memory to the primary memory in respective batches including multiple external device data samples.

9. The SoC device of claim 1, wherein the secondary processor is configured to acquire the external device data from the external device, and store the external device data acquired in the secondary memory during a sleep state of the primary processor.

10. A method, comprising:
storing instructions in a primary memory of a system-on-a-chip (SoC) device;
accessing and executing the instructions, by a primary processor of the SoC device;
controlling a communication interface of the SoC device, by a secondary processor of the SoC device, to acquire external device data from an external device connected to the communication interface;
storing external device data acquired from the external device in a secondary memory of the SoC device; and
transmitting, by the secondary processor, the external device data from the secondary memory to the primary memory without interrupting the primary processor.

11. The method of claim 10, wherein the secondary processor comprises a finite state machine (FSM) or a reduced instruction set computer (RISC) core.

12. The method of claim 10, wherein the secondary processor operates at a lower frequency than the primary processor.

13. The method of claim 10, comprising controlling a direct memory access (DMA) controller, by the secondary processor, to transmit the external device data from the secondary memory to the primary memory using a DMA transfer.

14. The method of claim 10, wherein:
the external device comprises a sensor;
the external device data comprises sensor data samples;
the method comprises:
controlling the communication interface, by the secondary processor, to acquire a series of sensor data samples from the external device via the communication interface over time;
storing sensor data samples acquired from the external device in the secondary memory; and
transmitting, by the secondary processor, the sensor data samples from the secondary memory to the primary memory without interrupting the primary processor.

15. The method of claim 10, wherein the SoC device comprises a microcontroller.

16. The method of claim 10, comprising:
pre-processing, by the secondary processor, the external device data acquired from the external device to provide pre-processed external device data, wherein the pre-processing includes at least one of data filtering, averaging, unit conversion, or error detection; and
transmitting, by the secondary processor, the pre-processed external device data from the secondary memory to the primary memory.

17. The method of claim 10, comprising:
controlling the communication interface, by the secondary processor, to acquire a series of external device data samples from the external device via the communication interface over time;
storing the series of external device data samples in the secondary memory; and
transmitting, by the secondary processor, the external device data samples from the secondary memory to the primary memory in respective batches including multiple external device data samples.

18. The method of claim 10, comprising:
entering the primary processor in a sleep state; and
acquiring the external device data from the external device and storing the external device data acquired in the secondary memory, by the secondary processor, while the primary processor remains in the sleep state.

19. A system-on-a-chip (SoC) device, comprising:
a primary processor configured to operate in an active state and a sleep state;
a secondary processor configured to:
during a sleep state operation of the primary processor:
acquire external device data from an external device connected to the SoC device; and
store the acquired external device data in memory.

20. The SoC device of claim 19, wherein the secondary processor is configured to:
store the acquired external device data in a secondary memory; and
transmit the external device data from the secondary memory to a primary memory accessible by the primary processor without interrupting the primary processor.
